(19) United States
(12) Patent Application Publication
(10) Pub. No.: US 2014/0193034 A1
(43) Pub. Date: Jul. 10, 2014

(54) OBJECT DETECTION DEVICE, OBJECT DETECTION METHOD AND OBJECT DETECTION PROGRAM

(71) Applicants: Ryoma Oami, Minato-ku (JP); Yasufumi Hirakawa, Minato-ku (JP)

(72) Inventors: Ryoma Oami, Minato-ku (JP); Yasufumi Hirakawa, Minato-ku (JP)

(73) Assignee: NEC CORPORATION, Tokyo (JP)

(21) Appl. No.: 14/127,872

(22) PCT Filed: May 21, 2012
(86) PCT No.: PCT/JP2012/062941

§ 371 Date: Feb. 21, 2014

(30) Foreign Application Priority Data
Jun. 27, 2011 (JP) 2011-141508

(51) Int. Cl. G06K 9/46; G06K 9/00

(52) U.S. Cl. CPC G06K 9/46; G06K 9/00362
USPC 382/103

(57) ABSTRACT

The present invention accurately detects an object from a video image where large distortion of an image may be generated for covering a wide field of view. An object detection device 1 that detects an object from a camera image captured by a camera having a wide field of view and causing distortion varying according to a position in an image includes: a candidate area selection unit 10 configured to select candidate areas for detecting the object from the camera image, and generate candidate area information identifying the candidate areas, and positional parameter information indicating distances from the center of the camera image to the candidate areas; and an object detection unit 20 configured to select, on the basis of the positional parameter information corresponding to the candidate areas, an object detection system used when detecting the object from the candidate areas, rotate the candidate areas with respect to the center of the camera image in order to unify directions from the candidate areas to the center of the camera image to the same direction, and detect whether or not the object exists in each of the candidate areas, the directions of which being unified.

### BACKGROUD

The present invention relates to an object detection device, an object detection method and an object detection program.

Recently, a technology of detecting a person from a video image captured by a camera mounted with a fisheye lens (hereinafter, referred to as a “fisheye lens camera”) or an omnidirectional camera has been developed. The following Patent Document 1 discloses a technology of detecting a person from an image captured by an omnidirectional camera. The technology described in this Patent Document 1 will be briefly described with reference to a schematic configuration diagram shown in FIG. 10.

An area determination unit 51 in FIG. 10 detects a moving rectangular area from an image captured by an omnidirectional camera. The area determination unit 51 determines whether or not the detected rectangular area matches preset object size, and notifies an image perspective transformation unit 52 of the rectangular area, when the detected rectangular area matches the preset object size. The image perspective transformation unit 52 performs perspective transformation to the notified rectangular area, and outputs a perspective projection image after transformation to an object detection unit 53. The object detection unit 53 performs object detection to the received perspective projection image. At this time, object detection is performed by using the same pattern.

The following Patent Document 2 discloses a technology of detecting a person from an image captured by a fisheye lens camera. The technology described in this Patent Document 2 will be briefly described with reference to a schematic configuration diagram shown in FIG. 11.

A weighted inter-frame difference detection unit 61 in FIG. 11 calculates an inter-frame difference value, which is weighted according to the distance from the center of a lens, on the basis of the image captured by the fisheye lens camera. A raster scan processing unit 62 compares the inter-frame difference value calculated by the weighted inter-frame difference detection unit 61 with a preset threshold value, and extracts an area that is more likely an area of a person. This processing is performed to all images, and the area that is more likely an area of a person is notified to a trapezoidal area searching unit 63. The trapezoidal area searching unit 63 searches a trapezoidal-shaped area from the notified area. When the trapezoidal-shaped area is found, the trapezoidal-shaped area is cut out, and a notification is given to a person detection unit 64. The person detection unit 64 detects a person area by checking the size and the shape of the cut-out area by using a normalized trapezoidal-shaped person-shaped model.

The following Patent Document 3 discloses a technology of switching algorithm or a dictionary used when detecting an object, depending on the position of the object in an image captured by a fisheye lens camera, i.e., the position located in the vicinity of the center or the position located in the vicinity of the periphery.

Patent Document 1: Patent Publication JP-A-2010-199713

Patent Document 2: Patent Publication JP-A-H11-261868

Patent Document 3: Patent Publication JP-A-2007-25767

In the technology described in Patent Document 1, the object is detected after the perspective transformation, regardless of whether or not a person is present in the image, and hence a region where the number of pixels is small and information is poor is also extended (enlarged) by the perspective transformation. That is, the object is detected regardless of whether the amount of information is great or not, and hence the detection accuracy of the object is lowered when a large part of the area which is subjected to the perspective transformation is an area where the information is poor.

In the technology described in Patent Document 2, regardless of the fact that the viewed appearance of a person captured by the fisheye lens camera is different depending on the position where the person is imaged, the person is detected by using the same person-shaped model without considering the position where the person is imaged. Therefore, in an area where the imaged appearance of the person differs from the person-shaped model, the detection accuracy of the person is lowered.

In the technology described in Patent Document 3, regardless of the fact that the direction, the posture or the like of an object captured by the fisheye lens camera varies according to a position where a video image of the object is captured, the change of the direction, the posture or the like is not considered at all. Therefore, in a case where the direction, the posture or the like of the captured object is greatly changed compared to a criterion, the detection accuracy of the object is lowered.

### SUMMARY

The present invention has been conceived in order to solve the aforementioned problems, and a purpose is to provide an object detection device, an object detection method, and an object detection program which are capable of accurately detecting an object from a video image where large distortion may be generated for covering a wide field of view, for example a video image captured by the fisheye lens camera or the omnidirectional camera. Note that the object includes a person.

An object detection device of the present invention is an object detection device that detects an object from a camera image captured by a camera which has a wide field of view and causes distortion varying according to a position in an image, the object detection device including: a candidate area selection unit configured to select candidate areas for detecting the object from the camera image, and generate candidate area information identifying the candidate areas, and positional parameter information indicating distances from the center of the camera image to the candidate areas; and an object detection unit configured to select, on the basis of the positional parameter information corresponding to the candidate areas, an object detection system used when detecting the object from the candidate areas, rotate the candidate areas with respect to the center of the camera image in order to unify directions from the candidate areas to the center of the camera image to the same direction, and detect whether or not the object exists in each of the candidate areas, the directions of which being unified.

An object detection method of the present invention is an object detection method of detecting an object from a camera image captured by a camera which has a wide field of view and causes distortion varying according to a position in an image, the object detection method including: a candidate area selection step of selecting candidate areas for detecting the object from the camera image, and generating candidate area information identifying the candidate areas, and positional parameter information indicating distances from the center of the camera image to the candidate areas; and an object detection step of selecting, on the basis of the positional parameter information corresponding to the candidate areas, an object detection system used when detecting the object from the candidate areas, rotating the candidate areas with respect to the center of the camera image in order to unify directions from the candidate areas to the center of the camera image to the same direction, and detecting whether or not the object exists in each of the candidate areas, the directions of which being unified.

An object detection program of the present invention causes a computer to implement the respective steps included in the aforementioned object detection method.

According to the present invention, it is possible to accurately detect an object from a video image where large distortion of an image may be generated for covering a wide field of view, like a video image captured by a fisheye lens camera or an omnidirectional camera, for example.

### DESCRIPTION OF DRAWINGS

FIG. 1 is a diagram of illustrating the configuration of an object detection device according to an embodiment;

FIG. 2 is a diagram of illustrating the relation between a video image captured by a fisheye lens camera, and a candidate area;

FIG. 3 is a diagram of illustrating the relation between a video image captured by an omnidirectional camera, and a candidate area;

FIG. 4 is a diagram of illustrating the configuration of a candidate area selection unit in FIG. 1;

FIG. 5 is a flowchart for illustrating the process of object detection processing;

FIG. 6 is a diagram of illustrating the configuration of an object detection unit in FIG. 1;

FIG. 7 is a diagram of illustrating a candidate area before rotation correction;

FIG. 8 is a diagram of illustrating a candidate area after the rotation correction;

FIG. 9 is a diagram of illustrating the configuration of a candidate area selection unit according to a modification;

FIG. 10 is a diagram for illustrating the schematic configuration of a conventional manner (Patent Document 1); and

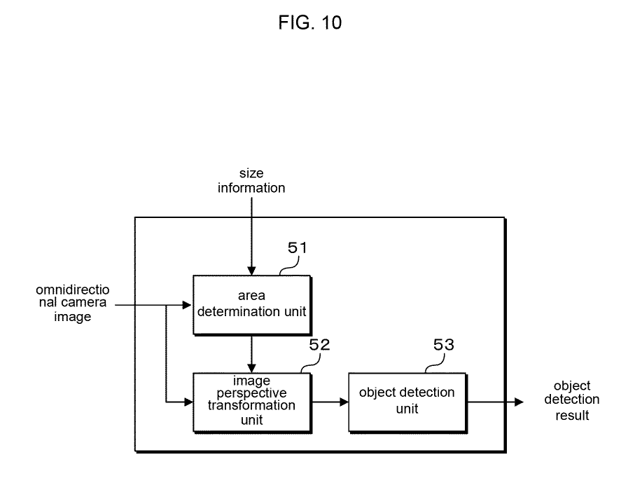

FIG. 11 is a diagram for illustrating the schematic configuration of a conventional manner (Patent Document 2).

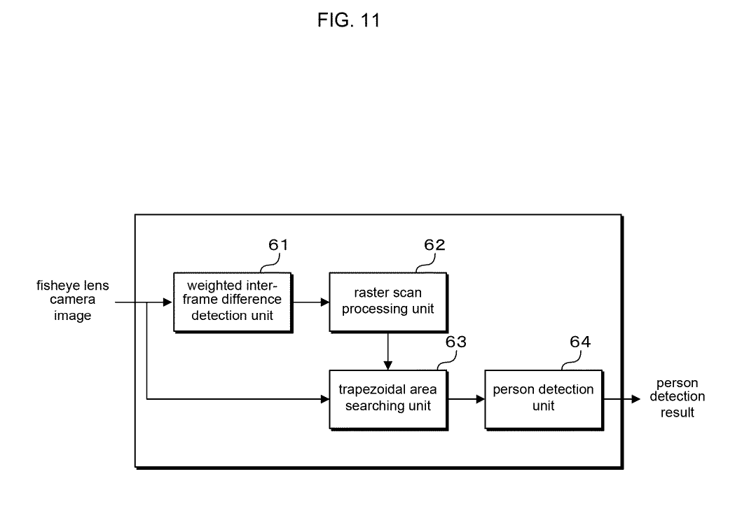

### DETAILED DESCRIPTION

Hereinafter, the preferred embodiments of an object detection device, an object detection method, and an object detection program according to the present invention will be described with reference to the attached drawings.

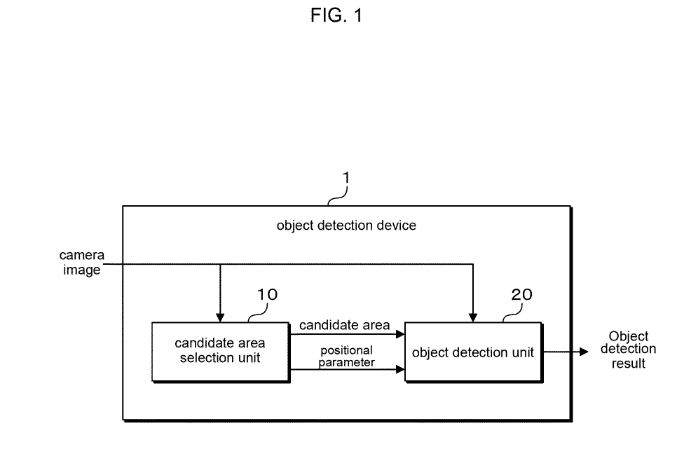

With reference to FIG. 1, the configuration of the object detection device according to the embodiment will be described. An object detection device 1 functionally has a candidate area selection unit 10 and an object detection unit 20.

Here, the object detection device 1 physically includes elements of, for example, a CPU (Central Processing Unit), a storage device, and an input-output interface. The storage device includes, for example, a ROM (Read Only Memory) or an HDD (Hard Disk Drive) storing data and a program processed in the CPU, a RAM (Random Access Memory) mainly used as various work areas for control processing, and the like. These elements are connected to each other through busses. The CPU executes a program stored in the ROM, and processes data received through the input-output interface, or data developed in the RAM, or the like, thereby enabling the functions of the respective units of the object detection device 1 to be achieved.

The candidate area selection unit 10 of FIG. 1 receives a camera image input from outside, and outputs candidate area information and positional parameter information to the object detection unit 20. The object detection unit 20 receives the candidate area information and the positional parameter information output by the candidate area selection unit 10, and outputs an object detection result to the outside.

The camera image received by the candidate area selection unit 10 is a video image captured by a camera capable of keeping a wide field of view in a single image, such as a fisheye lens camera and an omnidirectional camera, for example. Such a camera image includes geometric distortion for covering the wide field of view, and has a feature that the viewed appearance of an object varies according to the position in the image. In a case where an input video image is compressed, the video image is first decoded, and a frame image is generated.

The candidate area selection unit 10 selects areas, in which the object is more likely to exist, as candidate areas from the frame image.

Here, the candidate areas mean image areas, for which the object detection unit 20 at a subsequent stage attempts to perform object detection, and which are obtained by cutting out parts in the image. In a case where the object is likely to exist in any area in the image, the area in the image may be evenly divided to make candidate areas. On the other hand, for example, in a case where an obstacle or the like is placed, or a column or the like exists, and therefore a position, at which the object can exist, is not a whole of the image, and is limited to a part of the image, only a possibly existing part may be evenly divided to make candidate areas. Additionally, in a case where an object has a feature in color or shape, the candidate areas may be selected by this feature as a clue. The details thereof will be described later.

The candidate area selection unit 10 calculates a positional parameter, in which the viewed appearance of an object to be detected is associated with a position in an image, for each candidate area. The positional parameters will be hereinafter described.

The viewed appearance (imaged appearance) of the object varies according to the position in the image for covering the wide field of view as described above. For example, in a case of capturing by the fisheye lens camera placed to be directed downward from a ceiling, the central portion of the image near the center of a lens becomes an image obtained by capturing the object from directly above. On the other hand, the peripheral portion of the image distant from the center of the lens becomes an image captured such that a vertical direction is directed to the center of the image. As an object image approaches the peripheral portion of the image, geometric distortion becomes larger.

Thus, the viewed appearance of the object varies according to a distance from the center. Therefore, the candidate area selection unit 10 calculates distances from the center to the candidate areas, and the distances are used as the positional parameters.

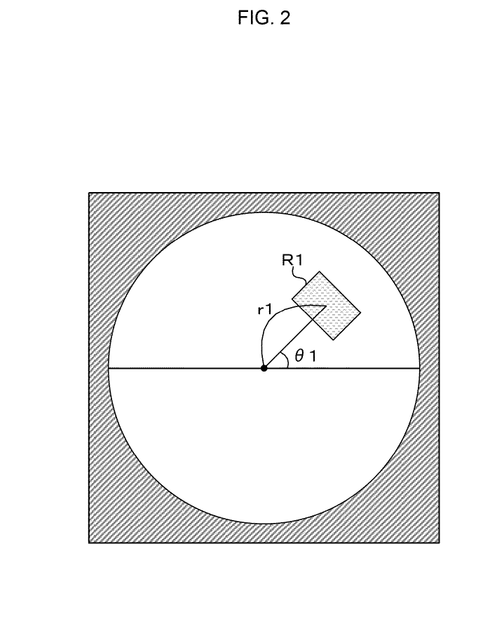

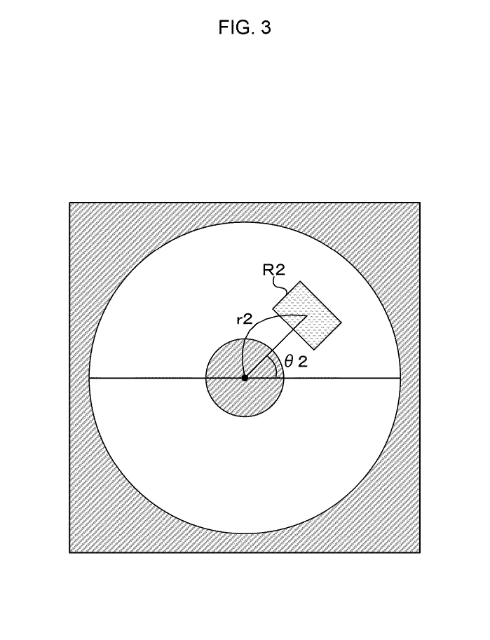

With reference to FIG. 2 and FIG. 3, the positional parameters will be specifically described. FIG. 2 is an image captured by a fisheye lens camera, and FIG. 3 is an image captured by a reflecting mirror typed omnidirectional camera. In the case of FIG. 2, the candidate area selection unit 10 calculates a distance r1 from the lens center of the fisheye lens camera to a candidate area R1 as the positional parameter. In the case of FIG. 3, the candidate area selection unit 10 calculates a distance r2 from the lens center of the omnidirectional camera to a candidate area R2 as the positional parameter. Hereinafter, a distance calculated in a similar manner to the distance r1 and the distance r2 is hereinafter referred to as a “distance from the center”.

The size or the shape of each candidate area may be changed according to the distance from the center in consideration of the change in the size of the object due to lens distortion. For example, the imaged size of the object is large in the vicinity of the center, and is small on the periphery, and hence the size of the candidate areas may be increased in the vicinity of the center, and the larger the distance from the center is, the smaller the size of the candidate areas may be made.

The size or the shape of each candidate area may be changed according to an object detection system selected by the object detection unit 20 at the subsequent stage. For example, the region of the object suitable for detection is selected for each object detection system selected, and hence the size or the shapes of the candidate areas may be changed according to the region of the object selected by the object detection system.

The candidate area selection unit 10 outputs, to the object detection unit 20, the candidate area information for identifying each of selected candidate areas, and the positional parameter information calculated for each candidate area.

The candidate area information includes information where the positions, the shapes, or the like of the candidate areas are described. As long as the candidate areas can be uniquely identified, this description method may be any description method. For example, in a case where the candidate area is a square, the combination of the coordinates of the center and the length of a single side may be employed as the candidate area information. Additionally, in a case where the candidate area is a polygon, the information of the apexes may be employed as the candidate area information. Furthermore, the combination of the coordinates of a point in the candidate areas, and the information of the area cut out around this point may be employed as the candidate area information. In a case where the shape or the size of the area cut out around the point is predetermined, only the coordinate information may be employed as the candidate area information.

The aforementioned predetermined shape or size of the area may be changed according to designated coordinates. For example, the shape or the size of an area cut out around a point may be preset according to a distance from the center to this point, and the shape or the size of the area may be determined by using the coordinates of the designated point.

The positional parameter information includes information indicating the distance from the center. For example, in a case where the distance from the center is quantized, and the shape or the size of the area is set according to a quantized value, an index value of the quantization may be included in the positional parameter information, in place of the distance from the center.

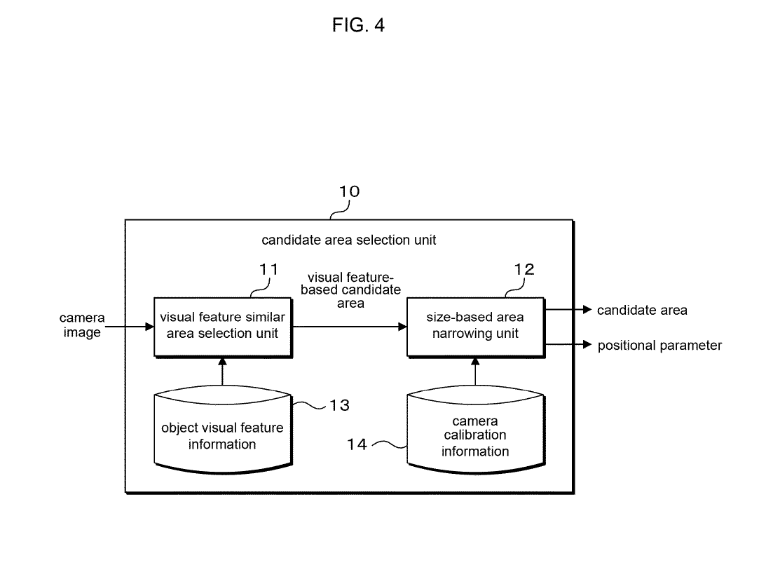

The aforementioned candidate area selection unit 10 may include, for example, a visual feature similar area selection unit 11, and a size-based area narrowing unit 12, as shown in FIG. 4.

The visual feature similar area selection unit 11 receives camera image input from outside, and outputs visual feature-based candidate area information to a size-based area narrowing unit 12 with reference to object visual feature information stored in an object visual feature information DB 13 on the basis of this camera image. The size-based area narrowing unit 12 receives the visual feature-based candidate area information output from the visual feature similar area selection unit 11, and outputs candidate area information and positional parameter information to the object detection unit 20 with reference to camera calibration information stored in a camera calibration information DB 14 on the basis of this visual feature-based candidate area information.

The object visual feature information DB 13 stores, as the object visual feature information, information on the visual feature of the object to be detected.

As the visual feature for example, the feature of the color, the pattern, the shape, or the like of the object can be used. For example, in a case where the object has a unique color, the feature of this color is calculated and used as the visual feature. Additionally, in a case where the object has a unique pattern, the feature of this pattern is calculated and used as the visual feature. Furthermore, in a case where the object has a unique shape, the feature of this shape is calculated and used as the visual feature.

Hereinafter, a case where the feature of a color is used as the visual feature will be described. A case where the feature of a pattern or a shape is used as the visual feature can be also applicable, similarly to the case of using the feature of the color.

The object visual feature information DB 13 stores, as the object visual feature information, the information on the feature of the color of the object to be detected. For example, in a case where the object to be detected is a human wearing a cap or helmet, possible upper or lower limit values of color components of the cap or the helmet correspond to the feature of the color. Specifically, R (Red), G (Green), and B (Blue) values of the cap or the helmet are analyzed, and the possible upper and lower limits of the respective values are used as the feature of the color. At this time, in consideration of the possible change of the color of the object due to the state of an object surface or the condition of light, the upper and lower limits of the RGB values preferably allow leeway to some extent. A color space in analyzing the color components is not limited to a RGB color space, and, for example, a HSV (Hue Saturation Value) color space or a L*a*b color space may be employed.

The visual feature similar area selection unit 11 extracts, with reference to the object visual feature information DB 13, pixels having colors falling within the ranges of various values stored as the object visual feature information from a camera image, and constructs a candidate areas.

Information stored as the object visual feature information is not limited to the upper and lower limits of the color components. For example, a distribution of the colors of the object is simulated, and information on this simulated distribution of the colors may be employed as the object visual feature information. In this case, the visual feature similar area selection unit 11 calculates, on the basis of the distribution of the colors stored as the object visual feature information, likelihood that each pixel of the camera image can be an object color, extracts, from the camera image, the pixel, in which this likelihood is a constant value or more, and constructs the candidate areas. In a case where the color distribution is regarded as a normal distribution, the standard deviation and the average of the simulated color distribution are stored as the object visual feature information, and the likelihood that each pixel of the camera image can be the object color is calculated by using the standard deviation and the average included in the object visual feature information.

A typical color indicating a representative color of the object may be stored as the object visual feature information. In this case, the visual feature similar area selection unit 11 calculates the degree of similarity between the color of each pixel of the camera image and the typical color, extracts, from the camera image, the pixels, in which this degree of similarity is a constant value or more, and the candidate areas are constructed. As the criterion of the degree of similarity, for example, an inner product between the color components can be employed. On the other hand, as the criterion of the degree of similarity, a distance between the color components can be also used. In this case, the pixel, in which the calculated degree of similarity is a constant value or less, is extracted from the camera image, and the candidate areas are constructed.

Here, in a case of capturing with the fisheye lens camera or the omnidirectional camera, the viewed appearance often varies as a distance from the center increases. For example, in a case where the visual feature is the feature of a color, the distribution of the colors of the object imaged on the periphery is sometimes wider than that in the vicinity of the center. Additionally, the visual feature is the feature of the pattern, a fine pattern on the periphery sometimes cannot be extracted compared to that in the vicinity of the center.

Thus, in a case where the feature varies according to the distance from the center, for example, the information of the visual feature of the object may be recorded on the object visual feature information DB 13 according to the distance from the center, and the visual feature similar area selection unit 11 may switch, according to the coordinates of the pixel, the visual feature information used for candidate area extraction.

For example, the visual feature information being the basis of the object, and information for adjusting the visual feature according to the distance from the center may be recorded on the object visual feature information DB 13, and the visual feature similar area selection unit 11 may adjust the visual feature information being the basis according to the position of the pixel, and use the adjusted visual feature information for the candidate area extraction.

The visual feature similar area selection unit 11 generates the information of the position and the size for identifying the candidate areas, and outputs this generated information as the visual feature-based candidate area information to the size-based area narrowing unit 12.

The pixels or the candidate areas extracted by the visual feature similar area selection unit 11 are not limited to those always extracted in a unified manner, for example, like the pixels or the candidate areas extracted by dividing into small areas due to the influence of a illumination condition, noise or the like. Therefore, the processing of integrating the pixels or the small areas having similar visual features in the vicinity may be performed and the integrated areas may be selected as the candidate area. For example, the pixels having the deference of the visual features within a constant value may be integrated by labeling processing or morphological processing, and unified into an area having larger particle size, and thereafter selected as the candidate area.

The size-based area narrowing unit 12 calculates the superficial size of the object by using the size of each candidate area included in the visual feature-based candidate area information received from the visual feature similar area selection unit 11, and the camera calibration information stored in the camera calibration information DB 14. The size-based area narrowing unit 12 determines whether the area is a possible candidate of the object on the basis of the calculated superficial size of the object, and selects only the candidate areas with the size suitable as the object.

Specifically, the selection is performed as described below. First, possible upper and lower limit values as the superficial size of the object at each position in the image are previously calculated on the basis of the information on the actual size of the object, and the calibration information. The size-based area narrowing unit 12 determines whether the size of each candidate area falls within the range of the previously calculated upper and lower limit, and selects only the candidate areas falling within the range.

The selection method is not limited to this method, and, for example, the size-based area narrowing unit 12 may calculate the likelihood of the object according to difference between the size of each candidate area and the superficial size of the object, and select the candidate areas where this likelihood is a constant value or more.

The size-based area narrowing unit 12 outputs information on the selected candidate areas as the candidate area information to the object detection unit 20. Additionally, the size-based area narrowing unit 12 calculates a distance from the center for each of selected candidate areas, and outputs this distance from the center as the positional parameter information to the object detection unit 20 together with the candidate area information.

The object detection unit 20 shown in FIG. 1 performs object detection processing to the candidate areas included in the candidate area information received from the candidate area selection unit 10. The object detection processing is performed by switching the object detection system according to the distance from the center being the value of the positional parameter. That is, the object detection unit 20, which is mounted with a plurality of object detection systems, selects a single object detection system according to the distance from the center, and performs the object detection processing.

The object detection system includes an agreement used when the region of the object suitable for detection is selected according to the distance from the center, by considering that the viewed appearance of the object varies according to the distance from the center. Hereinafter, the object detection system selected according to the distance from the center by the object detection unit 20 will be specifically described.

For example, in a case where the object to be detected is a person, when the distance from the center is near 0, only the top of a head is captured, and feet are not often captured. Particularly, in a case where the person holds a thing, this tendency is significant. Therefore, when the distance from the center is near 0, an object detection system for detecting the top of the head is selected. In a case where the person wears a working cap or a helmet, an object detection system for detecting the working cap or the helmet is selected.

On the other hand, as the distance from the center increases, the size of the area of the head reduces, and it becomes difficult to detect the person only by detecting the top of the head. Therefore, when the distance from the center is large, an object detection system for detecting an upper body portion in addition to the top of the head is selected.

Specifically, when an imaged distance is a distance to a face of the person naturally standing, an object detection system for detecting an area including from the head to around shoulders is selected. When the imaged candidate distance is further separated from the center, the area of the face becomes smaller, and the imaged distance is a distance where a whole body is fully imaged, an object detection system detecting an area including from the head to around breasts or a belly is selected.

In the case where the person holds a thing, an object detection system for detecting an area including the upper body portion excluding the thing as much as possible is selected. However, the person rarely holds a large thing, and therefore an object detection system for detecting the area of the whole body including the feet at an imaged distance where the whole body is fully video imaged may be selected, in a situation where the feet are fully imaged.

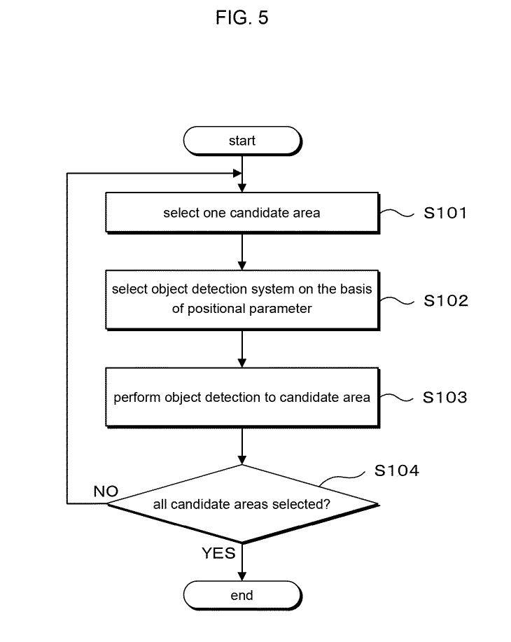

With reference to FIG. 5, the process of the object detection processing will be described.

First, the object detection unit 20 selects a single candidate area from the candidate areas included in the candidate area information received from the candidate area selection unit 10 (Step S101).

The object detection unit 20 selects an object detection system on the basis of the positional parameter information corresponding to the selected candidate area (Step S102).

The object detection unit 20 performs object detection to the candidate area in a camera image by using the selected object detection system (Step S103), and calculates an object detection result indicating whether or not the object exists in the candidate area.

The object detection unit 20 determines whether or not all of the candidate areas are selected (Step S104). When this determination is NO (Step S104; NO), the process advances to the aforementioned Step S101. When this determination is YES (Step S104; YES), the object detection processing is terminated.

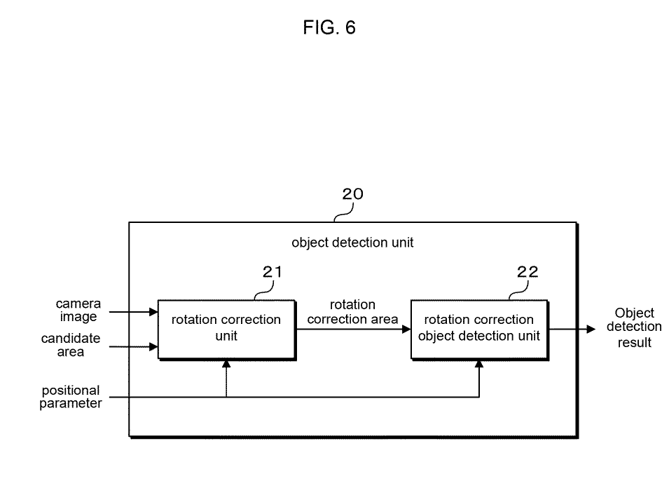

The aforementioned object detection unit 20 may includes, for example, a rotation correction unit 21, and a rotation correction object detection unit 22, as shown in FIG. 6.

The rotation correction unit 21 receives a camera image input from outside, and candidate area information and a positional parameter information output by the candidate area selection unit 10, and outputs rotation correction area information to the rotation correction object detection unit 22. The rotation correction object detection unit 22 receives the rotation correction area information output by the rotation correction unit 21, and the positional parameter information output by the candidate area selection unit 10, and outputs an object detection result to the outside.

The rotation correction unit 21 rotates the candidate areas included in the received candidate area information, and the direction of the object is unified to the same direction. As the unified direction, for example, a vertical direction or a horizontal direction can be used, but other direction may be employed as long as the direction of the object after rotation can be unified to the same direction.

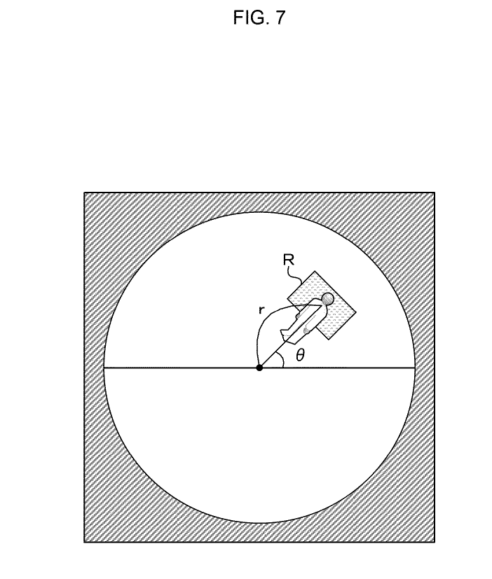

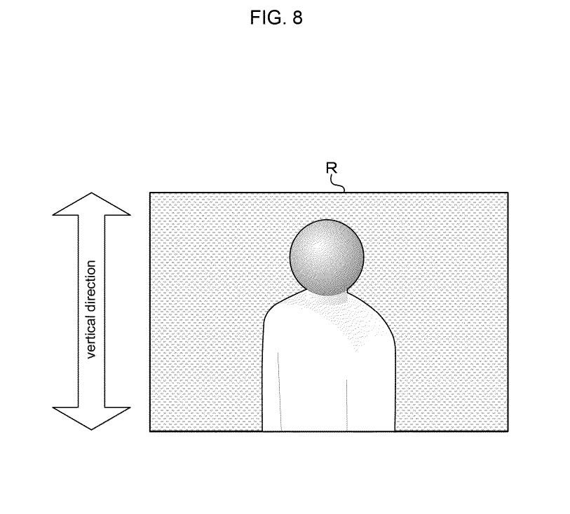

With reference to FIG. 7 and FIG. 8, a case where the direction of the object is unified to the vertical direction will be specifically described. In a case where the candidate area included in the candidate area information is a candidate area R including a person shown in FIG. 7, the rotation correction unit 21 rotates the direction of the candidate area R such that the head side of the person in the candidate area R is located on top, and the leg side is located on bottom, as shown in FIG. 8. When the direction of the candidate area R is rotated, the rotation correction unit 21 rotates the candidate area about a lens center employed as a rotation axis (basis).

A rotation angle in rotating the candidate area R can be calculated as described below, for example.

The rotation correction unit 21 calculates the azimuth angle θ of the candidate area R shown in FIG. 7, obtains a difference from an azimuth angle θ0 being a reference, and rotates the candidate area R by this difference. An example of unifying the direction of the object to the vertical direction will be specifically described. In this case, a reference azimuth angle θ0 is 90 degrees. Therefore, the rotation correction unit 21 calculates a difference between the azimuth angle θ of the candidate area R in FIG. 7 and 90 degrees, and rotates the candidate area R in a counterclockwise direction by this difference. Consequently, the direction of the candidate area R is corrected to the vertical direction (rotation correction) (see FIG. 8).

In parallel to the aforementioned rotation correction processing by the rotation correction unit 21, the object detection unit 20 performs the normalization processing of normalizing the size of the candidate area R in order to adapt to the object detection system selected according to the positional parameter information (distance from the center r). This normalization processing can be performed as described below, for example.

The object detection unit 20 samples pixels in the candidate area based on the size of an area processed by the selected object detection system, and calculates a pixel value in the candidate area after rotation correction.

Specifically, the process of the normalization processing performed in a case where the object detection system performs object detection to a rectangular image of M×N will be hereinafter described.

First, the object detection unit 20 calculates the positional coordinates of each pixel after rotation correction such that the size of the candidate area after rotation correction is M×N. Next, the object detection unit 20 calculates positional coordinates before rotation correction corresponding to the calculated positional coordinates of the respective pixels after rotation correction. Then, the object detection unit 20 calculates pixel values at the calculated respective positional coordinates before rotation correction. Thereafter, the object detection unit 20 employs the calculated pixel values as pixel values at the positional coordinates after rotation correction corresponding to the respective pixel values.

Here, in a case where no pixel exists on the positional coordinates before rotation correction calculated on the basis of the positional coordinates of the pixel after rotation correction, for example, the pixel value may be calculated by interpolating a pixel value around the positional coordinates before rotation correction.

The rotation correction unit 21 outputs rotation correction area information including information on the candidate area after rotation correction to the rotation correction object detection unit 22.

The rotation correction object detection unit 22 performs object detection processing to the candidate areas after rotation correction included in the rotation correction area information received from the rotation correction unit 21.

As a method of object detection processing, various method can be used. For example, a method of inputting the pixel value of the candidate area after rotation correction in a neural network caused to previously learn, and determining the existence or non-existence of the object can be used. Alternatively, a method of extracting a feature from the pixel value of the candidate area after rotation correction, inputting the feature in a discriminator such as a SVM (Support Vector Machine) and a LVQ (Learning Vector Quantization) caused to previously learn, and determining the existence or non-existence of the object.

A different method may be used according to the distance from the center, or only dictionary information may be switched by using the same method. In a case where only the dictionary information is switched, a plurality of discriminators may not be prepared, and therefore the rotation correction object detection unit 22 can be compactly mounted.

When the parameter of the feature such as the number of pixels and the number of dimensions used as the candidate areas after rotation correction are unified to the same, a data structure where the data of the candidate areas after rotation correction are stored is standardized regardless of the distance from the center, and therefore the rotation correction object detection unit 22 can be more compactly mounted.

The rotation correction object detection unit 22 outputs the results of object detection processing performed to the respective candidate areas after rotation correction as an object detection result to the outside.

According to the object detection unit 20 in this embodiment, the direction of the object to be detected can be unified to the same direction, and therefore dictionary information or learning data storing data in accordance with the data distance from the center can be used without providing the dictionary information or the learning data with respect to all positions on the image. Consequently, the size of the dictionary information or the learning data in detecting the object can be reduced.

As described above, according to the object detection device 1 in this embodiment, while considering that the viewed appearance of the object varies according to an imaged position, an object detection system most suitable for the position can be selected, and object detection can be performed to the object image captured on the image.

Consequently, with respect to an area where geometric distortion is large and the number of pixels is small, an object detection system using the area where the number of pixels is small with no change can be employed, and therefore reduction in detection accuracy resulting from the expansion of an area where information is poor can be prevented.

Additionally, the region used for object detection can be changed according to the viewed appearance of the object, and hence reduction in detection accuracy resulting from the use of the same model regardless of the imaged position of the object can be prevented.

Furthermore, the directions of the candidate areas can be rotated and corrected such that the angles of the candidate areas coincides with a reference angle, and can be unified to the same direction, and therefore reduction in detection accuracy resulting from the larger change of the direction or the posture of the captured object compared to the reference can be prevented.

Therefore, according to the object detection device 1 in this embodiment, an object can be accurately detected even from an image where large distortion may be generated for covering a wide field of view, like a video image captured by a fisheye lens camera or an omnidirectional camera.

### Modification

The aforementioned embodiment is not intended to be merely exemplary, and to eliminate the application of technology and various modifications that are not specified in the exemplary embodiment. That is, the present invention may be practiced with modifications to the various forms without departing from the scope and spirit thereof.

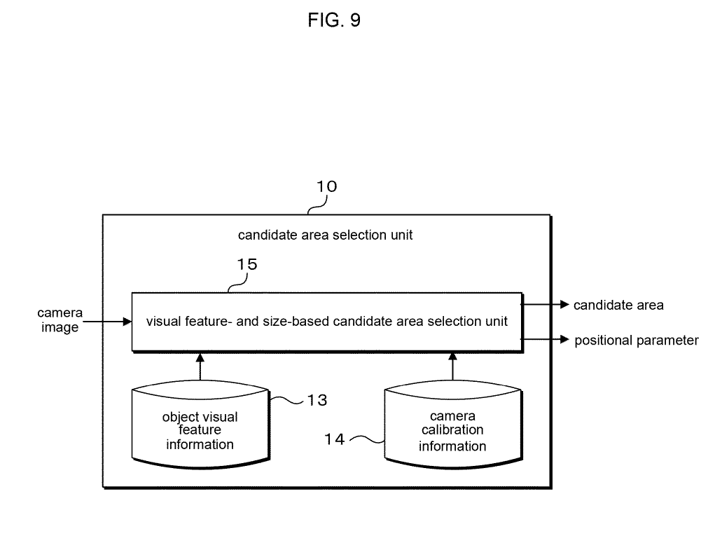

For example, the candidate area selection unit of the aforementioned embodiment is not limited to the configuration shown in FIG. 4. For example, as shown in FIG. 9, the candidate area selection unit may include a visual feature- and size-based candidate area selection unit 15.

The visual feature- and size-based candidate area selection unit 15 shown in FIG. 9 receives a camera image output from outside. The visual feature- and size-based candidate area selection unit 15 refers to object visual feature information stored in an object visual feature information DB 13 on the basis of the received camera image. The visual feature- and size-based candidate area selection unit 15 calculates likelihood with respect to each pixel or small area in the image by using object visual feature information, and camera calibration information stored in a camera calibration information DB 14, extracts pixels or small areas where this likelihood is a constant value or more, and constructs candidate areas.

A process used when referring to the object visual feature information DB 13 and the camera calibration information DB 14 is similar to that of the candidate area selection unit in the aforementioned embodiment. A point different from the candidate area selection unit in the aforementioned embodiment is to calculate the likelihood of an object by using both of an object visual feature and size at the same time and to select the candidate areas.

The visual feature- and size-based candidate area selection unit 15 outputs information on the selected candidate areas as the candidate area information to an object detection unit 20. The visual feature- and size-based candidate area selection unit 15 calculates the distances from the center of the selected candidate areas, and outputs the distances from the center as the positional parameter information to the object detection unit 20 together with the candidate area information.

A part or all of the present embodiments can be also described as in the following appendixes. However, the present invention is not limited to the following.

(Appendix 1) An object detection device that detects an object from a camera image captured by a camera which has a wide field of view and causes distortion varying according to a position in an image, the object detection device including: a candidate area selection unit configured to select candidate areas for detecting the object from the camera image, and generate candidate area information identifying the candidate areas, and positional parameter information indicating distances from the center of the camera image to the candidate areas; and an object detection unit configured to select, on the basis of the positional parameter information corresponding to the candidate areas, an object detection system used when detecting the object from the candidate areas, rotate the candidate areas with respect to the center of the camera image in order to unify directions from the candidate areas to the center of the camera image to the same direction, and detect whether or not the object exists in each of the candidate areas, the directions of which being unified.

(Appendix 2) In the object detection device described in Appendix 1, the candidate area selection unit is configured to select, as visual feature-based candidate areas, image areas having visual features similar to a previously registered visual feature of the object, calculate size of the object on the image at positions of the visual feature-based candidate areas by using previously registered calibration information of the camera, and select, as the candidate areas, areas which are more likely to include the object from among the visual feature-based candidate areas on the basis of the calculated size.

(Appendix 3) In the object detection device described in Appendix 1, the candidate area selection unit is configured to calculate likelihood of existence of the object in image areas, on the basis of a previously registered visual feature of the object, and previously registered calibration information of the camera, and select, as the candidate areas, image areas where the likelihood is at least a constant value. (Appendix 4) In the object detection device described in any of

Appendixes 1 to 3, the candidate area selection unit is configured to change size and shapes of the candidate areas on the basis of the object detection system selected by the object detection unit, or distances from the center of image areas.

(Appendix 5) In the object detection device described in any of Appendixes 1 to 4, the candidate area selection unit is configured to select the candidate areas on the basis of visual features and size of image areas.

(Appendix 6) In the object detection device described in any of Appendixes 1 to 5, the candidate area selection unit is configured to change a selection criterion used when selecting the candidate areas according to the distances from the center of image areas.

(Appendix 7) In the object detection device described in any of Appendixes 1 to 6, the object detection unit is configured to switch dictionary information used when detecting the object according to the distances from the center of the camera image, without changing a method of detecting the object according to the distances from the center of the camera image.

(Appendix 8) In the object detection device described in Appendix 7, in the object detection unit, parameters of features used in the same kind of the method remain the same regardless of the distances from the center of the camera image.

(Appendix 9) An object detection method of detecting an object from a camera image captured by a camera which has a wide field of view and causes distortion varying according to a position in an image, the object detection method including: a candidate area selection step of selecting candidate areas for detecting the object from the camera image, and generating candidate area information identifying the candidate areas, and positional parameter information indicating distances from the center of the camera image to the candidate areas; and an object detection step of selecting, on the basis of the positional parameter information corresponding to the candidate areas, an object detection system used when detecting the object from the candidate areas, rotating the candidate areas with respect to the center of the camera image in order to unify directions from the candidate areas to the center of the camera image to the same direction, and detecting whether or not the object exists in each of the candidate areas, the directions of which being unified.

(Appendix 10) An object detection program for causing a computer to implement the respective steps described in Appendix 9.

This application claims the conventional priority based on Japanese Patent Application No. 2011-141508 filed on Jun. 27, 2011, all disclosure of which is incorporated herein.

The object detection device, the object detection method, and the object detection program according to the present invention are suitable for accurately detecting an object from a video image where large distortion of an image may be generated for covering a wide field of view, like a video image captured by a fisheye lens camera or an omnidirectional camera, for example.

1 OBJECT DETECTION DEVICE

10 CANDIDATE AREA SELECTION UNIT

11 VISUAL FEATURE SIMILAR AREA SELECTION UNIT

12 SIZE-BASED AREA NARROWING UNIT

13 OBJECT VISUAL FEATURE INFORMATION DB

14 CAMERA CALIBRATION INFORMATION DB

15 VISUAL FEATURE- AND SIZE-BASED CANDIDATE AREA SELECTION UNIT

20 OBJECT DETECTION UNIT

21 ROTATION CORRECTION UNIT

22 ROTATION CORRECTION OBJECT DETECTION UNIT

1. An object detection device that detects an object from a camera image captured by a camera which has a wide field of view and causes distortion varying according to a position in an image, the object detection device comprising:
a candidate area selection unit configured to select candidate areas for detecting the object from the camera image, and generate candidate area information identifying the candidate areas, and positional parameter information indicating distances from the center of the camera image to the candidate areas; and
an object detection unit configured to select, on the basis of the positional parameter information corresponding to the candidate areas, an object detection system used when detecting the object from the candidate areas, rotate the candidate areas with respect to the center of the camera image in order to unify directions from the candidate areas to the center of the camera image to the same direction, and detect whether or not the object exists in each of the candidate areas, the directions of which being unified.

2. The object detection device according to claim 1, wherein
the candidate area selection unit is configured to select, as visual feature-based candidate areas, image areas having visual features similar to a previously registered visual feature of the object, calculate size of the object on the image at positions of the visual feature-based candidate areas by using previously registered calibration information of the camera, and select, as the candidate areas, areas which are more likely to include the object from among the visual feature-based candidate areas on the basis of the calculated size.

3. The object detection device according to claim 1, wherein the candidate area selection unit is configured to calculate likelihood of existence of the object in image areas, on the basis of a previously registered visual feature of the object, and previously registered calibration information of the camera, and select, as the candidate areas, image areas where the likelihood is at least a constant value.

4. The object detection device according to claim 1, wherein
the candidate area selection unit is configured to change size and shapes of the candidate areas on the basis of the object detection system selected by the object detection unit, or distances from the center of image areas.

5. The object detection device according to claim 1, wherein
the candidate area selection unit is configured to select the candidate areas on the basis of visual features and size of image areas.

6. The object detection device according to claim 1, wherein
the candidate area selection unit is configured to change a selection criterion used when selecting the candidate areas according to the distances from the center of image areas.

7. The object detection device according to claim 1, wherein
the object detection unit is configured to switch dictionary information used when detecting the object according to the distances from the center of the camera image, without changing a method of detecting the object according to the distances from the center of the camera image.

8. The object detection device according to claim 7, wherein
in the object detection unit, parameters of features used in the same kind of the method remain the same regardless of the distances from the center of the camera image.

9. An object detection method of detecting an object from a camera image captured by a camera which has a wide field of view and causes distortion varying according to a position in an image, the object detection method comprising:
a candidate area selection step of selecting candidate areas for detecting the object from the camera image, and generating candidate area information identifying the candidate areas, and positional parameter information indicating distances from the center of the camera image to the candidate areas; and
an object detection step of selecting, on the basis of the positional parameter information corresponding to the candidate areas, an object detection system used when detecting the object from the candidate areas, rotating the candidate areas with respect to the center of the camera image in order to unify directions from the candidate areas to the center of the camera image to the same direction, and detecting whether or not the object exists in each of the candidate areas, the directions of which being unified.

10. An object detection program for causing a computer to implement the respective steps according to claim 9.
